(19) United States
(12) Patent Application Publication
(10) Pub. No.: US 2004/0210463 A1
(43) Pub. Date: Oct. 21, 2004

(54) PROCESS TO MEASURE THE VALUE OF INFORMATION TECHNOLOGY

(76) Inventor: William Joseph Reid, Fairview, TX (US)

Correspondence Address: NETP&L, INC., 1385 SAGEBROOK DRIVE, FAIRVIEW, TX, 75069, US

(21) Appl. No.: 10/249,570

(22) Filed: Apr. 19, 2003

(51) Int. Cl. G06F 17/60

(52) U.S. Cl. 705/7

(57) ABSTRACT

A process to measure the value of a company's information technology organization as an intangible equity asset. These measurements may be used to make asset protection decisions and/or equity improvement investments.

### BACKGROUND OF INVENTION

Measurement of Information Technology value is of increasing interest to companies. For example, the Securities and Exchange Commission (SEC) regulations task executives and directors with both protecting equity (risk management) and growing equity. This invention provides a measurement of the information technology (IT) organization's intangible asset value to accomplish both objectives.

Prior art measurement of IT value has centered on determining payoffs from corporate investment in technology. As a result, fewer than 25% of organizations use any formal measures when evaluating their IT investments (Information Week 1997). A much broader view of the whole issue of “Knowledge Capital” has led to increased calls from IT researchers and practitioners for a more inclusive and comprehensive assessment of IT value. (Strassmann 1990; Brynjolfsson 1993; Hitt and Brynjolfsson 1996; Information Week 1997, Tallon, Kraemer and Gurbaxani 2002, CIO Magazine 2001).

The present invention teaches how to measure the information technology organization 'sintangible asset value.

### SUMMARY OF INVENTION

The present invention provides the means of measuring the value of the information technology organization 'sintangible equity asset value.

The present invention teaches combining the new art of separating the components of IT expense into equity generating components and non-equity generating components with the new art of using capital asset depreciation to develop the obsolescence factor for these IT equity generating labor expenses with the new art of evaluating the relevance of this potential IT equity generation using executive perception.

### BRIEF DESCRIPTION OF DRAWINGS

FIG. 1 illustrates the flow of processes to determine the value of an IT organization.

### DETAILED DESCRIPTION

The concept of measuring the value of an IT organization is enabled by the invention. Information Technology is one of a company's major intangible equity assets. Intangible equity ican bedefined as the difference between a company's capital assets and a company's market value. Intangible equity, like capital equity, is made up of numerous asset types that can be valued. This IT intangible equity asset value and other intangible equity assets values are part of the market value of a company, whether realized in the public market or unrealized in the private market. The view of equity determination will be from the investor viewpoint.

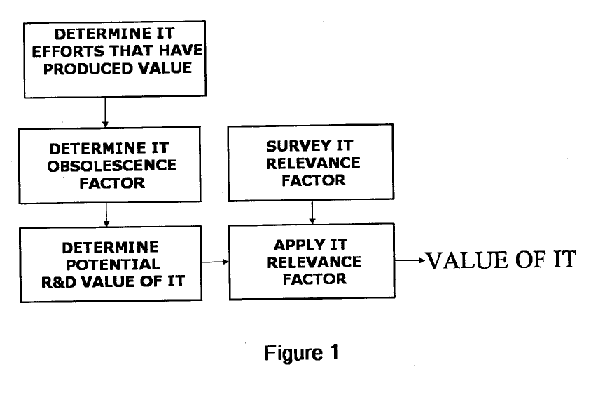

FIG. 1 shows the processes used in the invention to measure IT value. First the IT efforts that may have produced value are determined from IT budgets and related projects. Next the obsolescence factor of previous IT efforts is determined. From this information we may determine the potential value of IT efforts. The potential value assumes the IT efforts have been relevant in increasing the equity value of the company. The relevance factor of IT efforts is determined by a survey of management. This relevance factor is then used to adjust the potential value to determine the final value of IT.

The invention teaches that fit is irst iequired to separate IT expenses into maintenance and Research & Development (R&D) categories because maintenance expense has little or no equity value to an investor as every other competitive company is doing exactly the same thing. Maintenance is expenses like resetting passwords; adding users to servers and changing employee records. Maintenance could be as much as 50% of the IT budget. In many companies the correct determination is not to attribute any equity value to an IT maintenance function. An investor would not see value in something that does not add competitive advantage and a competitor could automate this maintenance function and then have a competitive advantage.

A typical IT organization may have the type of budget expense activities described in the IT Activities Table. The IT Activities Table also shows how these activities may be classified as R&D and Maintenance. Actual IT project expense budgets are generally at a much finer detail than shown in the IT Activities Table and some elements of each finer detail expense categories may be moved to either R&D or maintenance.

IT Activities

| | |
|---|---|
| R&D | Unique application development |
| R&D | Capital acquisition configuration & |
| | support |
| Maintenance | Infrastructure support |
| R&D/Maintenance | Company user support |
| R&D/Maintenence | Customer support |
| R&D | Product development |
| Maintenance | Communication infrastructure |

As the IT Activities Table shows the R&D part of IT is made up of custom configuration of software and hardware companies have purchased, developing new products and applications, and in general knowledge captured from both formal and informal training.

To determine a equity value for R&D we would need two factors. First, we would need a R&D obsolescence discount factor and second we would need an R&D relevance factor.

The obsolescence factor recognizes that the value of knowledge has a finite life. In information technology that life is generally short as technology changes rapidly. The invention recognizes companies have already made a decision on how to depreciate the IT capital hardware and software they have purchased. Capital asset acquisition configuration and support is typically a major part of R&D expense. Generally Accepted Accounting Principles (GAAP) depreciation has defined the useful life of those assets expense. A good first assumption is that the company's uniquely developed products and services labor expenses have a suseful life osimilar to IT capital assets.

The R&D obsolescence factor of the invention is an average IT capital depreciation is called R&D_Obsol. R&D_Obsol will be the discount factor for current and past R&D expenses. To develop a R&D_Obsol factor the capital asset expenditures from the current year and all previous years are determined from financial records. Leases may also be capitalized. The formula shows the calculation of the R&D_Obsol factor being equal to the current total value of capital asset acquisitions divided by the original value for all capital asset acquisitions that have a current value

$$R \& D\_Obsol factor = \frac{{\sum }^{} Current value of IT Capital Acquisition > \$}{{\sum }^{} Current value of IT Capital Acquisition}$$

With a finer level of definition of IT project budgets it my be useful to determine different obsolescence factors for each capital asset associated R&D expense. Different obsolescence factors may be associated with unique application development and with new product development.

The R&D_Obsol factor is then used to calculate the potential R&D present value as shown in this formula using past R&D budgets

$$Potential R \& D Present Value = {\sum }_{n = 1}^{n = R \& D\_Obsol} IT R \& D Budget {}_{n} [ 1 - \frac{n}{( R \& D\_Obs}$$

This term is called potential in that it makes the assumption that R&D efforts result in an increased value of a company. Certainly business cases that were developed to justify these projects have made that assumption. Potential value can be converted to a real value by determining a relevance factor of how successful R&D expenses were in either improving the performance of the company or by reducing the costs of company operations.

The Potential R&D Present Value calculation is shown with a linear or straight line method. Other present value methods could be used. For example, to take into account the value of money.

To develop the R&D relevance factor we use the work of Dr. Paul Tallon. Dr. Paul Tallon, Assistant Professor of Information Systems, Carroll Scholl of Management, Boston College has written and published numerous papers including: “Executives” Perceptions of the Business Value of Information Technology: A Process-oriented Approach” with Kenneth L. Kraemer and Vijay Gurbaxani. Journal of Management Information Systems, 16(4), 2000, pp. 137-165.

The admissibility of executives' perceptions has been the subject of some debate due to fears that executives (and IS executives in particular) will exaggerate their views on IT impacts as a means of self-promotion. Research has alleviating these concerns by showing that perceptual and objective measures of firm performance are highly correlated. In one such study by Venkatraman & Ramanujam (1987), senior executives were asked to rate their firm's performance relative to that of their major competitors using a number of different performance measures, including sales growth, net income growth and ROI. The resulting high degree of correlation between perceptual and objective performance measures, led the authors to conclude that perceptual data from senior managers can be employed as acceptable measures.

A recent study by the London School of Economics suggests that while executives might be favorably inclined toward IT, they are largely dissatisfied to date with how IT investments have performed (Compass 1999). Considering this level of dissatisfaction, it is unlikely that executives will exaggerate claims of payoffs from IT in fact, the reverse might hold.

Although perceptual measures of firm performance have been widely accepted in organizational research (Lawrence & Lorsch 1986), perceptual measures have only recently begun to appear in the IS literature. For example, DeLone & McLean (1992) argue that executives are ideally positioned to act as key informants in a qualitative assessment of IT impacts in their corporations. There is a twofold basis for this argument. First, as direct consumers of IT, executives can rely on personal experience when forming an overall perception of IT impacts (Davis & Olson 1985; Rockart & Flannery 1983). Second, as business executives become involved in IT investment decisions, they are increasingly exposed to the opinions of peers and subordinates regarding the performance of previous IT investments (Watson 1990). When combined, these arguments confirm that executives are an important source of information on IT impacts, thereby supporting the use of executives” perceptions in evaluating IT relevance.

The prior art of Dr. Tallon used executive perception as a relevance factor for all of IT, not just the equity generating potion this invention teaches. The prior art of Dr. Tallon also used executive perception as a relevance factor for a qualitative rank of IT rather that the asset value this invention teaches. The executive relevance may be divided into four categories.

The table of R&D Relevance shows the four categories that must be surveyed and assessed to determine how successful the R&D efforts were in generating equity.

[R&D Relevance]

| | | Maximum |
|---|---|---|
| | | Relevance |
| Category | Description | Factor |
| Unfocused | Unfocused firms lack concise goals for | 78% |
| | IT while their executives doubt whether | |
| | IT can contribute to their current or | |
| | future business success | |
| Operations | Firms that use IT to streamline internal | 83% |
| focused | business processes and to achieve | |
| | efficiency and effectiveness are labeled | |
| | operations focused firms. These firms | |
| | use IT to reduce cost, increase | |
| | productivity, reengineer key business | |
| | processes and to improve corporate | |
| | planning. | |
| Market | In contrast to operations focused firms | 92% |
| Focused | these firms use IT for more external- | |
| | oriented purposes such as expanding | |
| | existing markets and creating new | |
| | markets. Market expansion involves | |
| | using IT to extend the corporation's | |
| | reach into new geographic areas or | |
| | through increasing sales to existing | |
| | customers. Market creation, on the | |
| | other hand, involves using IT to identify | |
| | new customer segments or new | |
| | product or service varieties. | |
| Both Market | While some firms use IT for either | 100% |
| and | internal or external purposes, these | |
| operations | firms recognize that IT can support | |
| focused | both foci simultaneously. Firms who | |
| | espouse this dual focus extend their | |
| | use of IT beyond the pursuit of | |
| | efficiency and effectiveness to include | |
| | market expansion and new market | |
| | Creation. | |

The value of IT can then be calculated by combining the Potential R&D Present Value and the R&D Relevance Factor

IT Value=R&D Relevance Factor×Potential R&D Present V

The present invention teaches how the value of company's information technology organization can be measured as an intangible equity asset value. Knowing this asset value allows a company to both determine methods of protecting that asset value and potential methods to grow that asset value showing how the present invention provides a superior result in intangible equity asset management.

1. A method for determining the value of Information Technology or of an Information Technology organization by using information from the depreciation of Information Technology capital assets.

2. The method of claim 1, wherein the value is used to determine risk.

3. The method of claim 1, wherein the value is used in a business process to enhance shareholders' value.

4. The method of claim 1, wherein the value is used to provide information to existing or potential investors.

5. The method in claim 1, wherein an additional factor of relevance is used.

6. A method of separating Information Technology budgets or expenses into two or more categories to develop the value of Information Technology or of an Information Technology organization.

7. The method of claim 6, wherein the value is used to determine risk.

8. The method of claim 6, wherein the value is used in a business process to enhance shareholders' value.

9. The method of claim 6, wherein the value is used to provide information to existing or potential investors.

10. The method in claim 6, wherein an additional factor of relevance is used.

11. The method in claim 6, wherein the categories are maintenance and development.

12. A method of using project or expense budgets to determine the value of a company organization.

13. The method of claim 12, wherein the value is used to determine risk.

14. The method of claim 12, wherein the value is used in a business process to enhance shareholders' value.

15. The method of claim 12, wherein the value is used to provide information to existing or potential investors.

16. The method in claim 12, wherein an additional factor of relevance is used.

17. A method of using executive perception of the value of an organization to measure, or enhance a measurement, of a company's intangible asset value for that organization

18. The method of claim 17, wherein the value is used to determine risk.

19. The method of claim 17, wherein the value is used in a business process to enhance shareholders' value.

20. The method of claim 17, wherein the value is used to provide information to existing or potential investors.
